(19) United States
(12) Patent Application Publication
(10) Pub. No.: US 2025/0313048 A1
(43) Pub. Date: Oct. 9, 2025

(54) TUBELESS TIRE INFLATION VALVE

(71) Applicant: Stan’s Performance Products, LLC, Big Flats, NY (US)

(72) Inventors: Derek Bissett, Big Flats, NY (US); James Malta, State College, PA (US)

(21) Appl. No.: 18/627,024

(22) Filed: Apr. 4, 2024

(51) Int. Cl. B60C 29/00

(52) U.S. Cl. CPC B60C 29/005

(57) ABSTRACT

This presently disclosed technology is directed to new and improved tubeless tire inflation valves that are capable of being used with one or more of Schrader, Presta, or Dunlop valve bodies. Such tubeless tire inflation valves may comprise a valve housing to be screwed onto and sealed against a valve stem, the valve stem protruding from a wheel onto which a pneumatic tire is mounted and a poppet stem extending through a center of the valve housing, the poppet stem axially aligned with the valve stem and the valve housing. In a closed orientation of the tubeless tire inflation valve, the poppet stem circumferentially seats and seals against the valve housing. In an open orientation of the tubeless tire inflation valve, the poppet stem mechanically seats against the valve stem and is open to fluid flow through the valve stem and the valve housing and around the poppet stem.

### BACKGROUND

A tubeless tire is a pneumatic tire that does not require a separate inner tube for inflation. Unlike pneumatic tires that use a separate inner tube, tubeless tires have continuous ribs or beads molded integrally into the bead of the tire so that they are forced by the pressure of air inside the tire to seal with corresponding tire bead seats on metal rims of a corresponding wheel on which the tire is mounted.

Tubeless bicycle tires are an increasingly popular option, as they can use high air pressure for increased rolling efficiency or low air pressure for better traction in some road conditions without getting pinch flats because there is no tube to pinch between the rim and surface features that the tires roll over. Further, lower tire pressures can yield improved comfort and rolling performance on rough surfaces. Still further, as there is no inner tube, there is no friction between tire and tube, thereby increasing overall rolling efficiency. Further yet, many punctures in a tubeless bicycle tire will self-seal using liquid tire sealant present in the tire. Punctures that don't self-seal are often easy to fix using a tire plug.

Tubeless bicycle tire systems commonly require a compatible tire, an airtight wheel including sealed spoke holes (if they go all the way through the rim), a pair of opposing tire bead seats, and a valve stem attached and sealed to the wheel. Further, liquid sealant is often added inside the tire to improve air retention and seal holes from small punctures. However, such sealants can be messy and interfere with operation of the valve stem, particularly as the sealant coagulates and cures over time.

### SUMMARY

Implementations described and claimed herein address the foregoing problems by providing a tubeless tire inflation valve comprising a valve housing to be screwed onto and sealed against a valve stem, the valve stem protruding from a wheel onto which a pneumatic tire is mounted, and a poppet stem extending through a center of the valve housing, the poppet stem axially aligned with the valve stem and the valve housing. In a closed orientation of the tubeless tire inflation valve, the poppet stem circumferentially seats and seals against the valve housing. In an open orientation of the tubeless tire inflation valve, the poppet stem mechanically seats against the valve stem and is open to fluid flow through the valve stem and the valve housing and around the poppet stem.

Other implementations are also described and recited herein.

### BRIEF DESCRIPTION OF THE DRAWINGS

FIG. 1 illustrates a sectional view of an example tubeless tire inflation valve in a closed and secured orientation.

FIG. 2 illustrates a sectional view of an example tubeless tire inflation valve in a closed and unsecured orientation.

FIG. 3 illustrates a sectional view of an example tubeless tire inflation valve in an open orientation.

FIG. 4 illustrates a sectional view of another example tubeless tire inflation valve in a closed and secured orientation.

FIG. 5 illustrates a sectional view of another example tubeless tire inflation valve in a closed and secured orientation.

FIG. 6 illustrates a sectional view of another example tubeless tire inflation valve in a closed and unsecured orientation.

FIG. 7 illustrates a sectional view of another example tubeless tire inflation valve in an open orientation.

FIG. 8 illustrates a radial sectional view of a bicycle wheel and a valve stem with an asymmetric stopper protruding therefrom.

FIG. 9 illustrates a transverse sectional view of a bicycle wheel and a valve stem with an asymmetric stopper protruding therefrom.

FIG. 10 illustrates example operations for using a tubeless tire inflation valve to fill or release fluid from a pneumatic tire.

FIG. 11 illustrates example operations for removing a tubeless tire inflation valve from a valve stem for cleaning or replacement.

### DETAILED DESCRIPTION

Bicycle and other pneumatic tires are commonly equipped with one of three styles of valve housings, Schrader (American), Presta (French), or Dunlop (Woods or English) style valves, referred to herein as Schrader, Presta, or Dunlop valves, respectively. An air chuck is commonly used to connect a bicycle or other pneumatic tire to a source of compressed air via the Schrader, Presta, or Dunlop valve and inflate or deflate it. However, these valves typically provide insufficient air flow for initial seating of a tubeless tire to its corresponding wheel, do not allow for easy addition of sealant, and are often clogged by sealant due to their small overall diameter and/or small internal apertures.

Sealant is often added to tubeless tires using a syringe. A syringe can be used to inject sealant into a deflated tire with a corresponding valve core removed from the valve stem body. This presently disclosed technology is directed to new and improved tubeless tire inflation valves that are capable of being used with one or more of Schrader, Presta, or Dunlop valve bodies. The presently disclosed tubeless tire inflation valves have relatively large internal passages that permit a sufficiently high flow rate to initially seat a tire to a wheel. When desired or necessary, the presently disclosed tubeless tire inflation valves further allow for tool-less assembly and disassembly so that a user may clean any coagulated sealant from internal parts of the valve. In various implementations of the presently disclosed tubeless tire inflation valves, the valve core may be removed from or maintained within an associated valve housing.

The following disclosure uses bicycle pneumatic tubeless tires as an example, yet it is meant to be understood that a wide range of pneumatic tubeless objects, including but not limited to pneumatic tubeless tires, that utilize the tubeless inflation systems and methods described in detail below. These tubeless inflation systems and methods may utilize a variety of standard types, such as Schrader, Presta, or Dunlop valves, or a custom valve design. Further, the following disclosure uses air as an example fluid, but it is meant to be understood that a wide range of fluids, including various gasses and liquids could be added or withdrawn from a pneumatic tubeless object using the tubeless inflation systems and methods described herein.

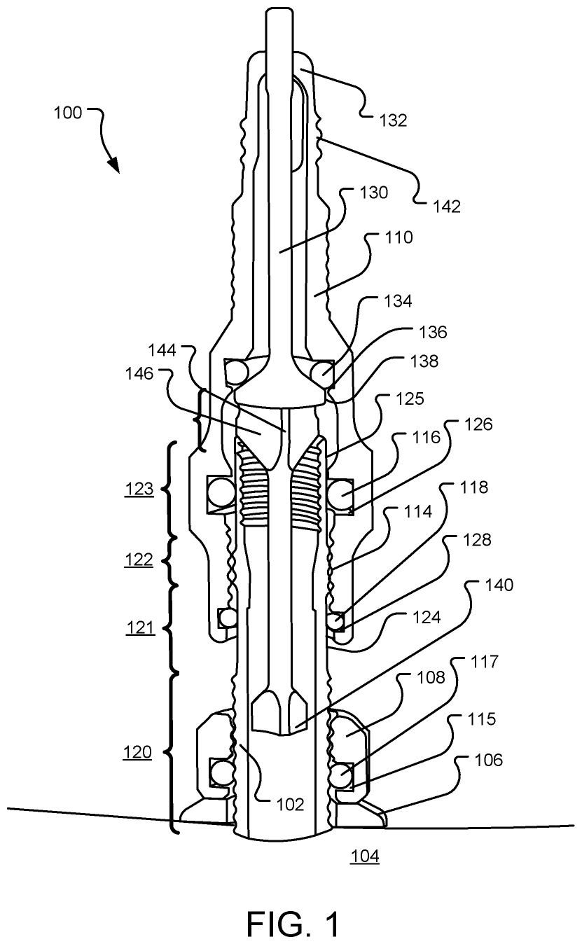

FIG. 1 illustrates a sectional view of an example tubeless tire inflation valve 100 in a closed and secured orientation. The tubeless tire inflation valve 100 includes a valve stem 102 that protrudes from a wheel (or rim) 104 onto which a pneumatic tire (not shown) is mounted. The valve stem 102 is sealed against the wheel 104 so that pressurized air is not permitted to escape from the wheel 104 at the interface of the wheel 104 with the valve stem 102.

Nut 108 includes O-ring 117 in internal recess 115 that functions as a locking mechanism and is screwed onto a first portion 120 of the valve stem 102. The first portion 120 of the valve stem 102 includes external threads for accepting corresponding internal threads of the nut 108. Reinforcing grommet 106 improves security of the nut 108 compressed against the wheel 104 profile. A pneumatic seal occurs on an unshown end of the valve stem 102 via a tapered grommet that is pressed into the rim hole via force applied to the valve stem 102 via the nut 108. The valve stem 102 is customized for the presently disclosed technology (see e.g., smooth external surfaces 124, 125 of portions 121, 123, respectively, discussed below), though common valve stem styles (e.g., Presta, Schrader, or Dunlop) could be used similarly.

The first portion 120 of the valve stem 102 includes external threads for accepting corresponding internal threads of the nut 108, as discussed above. A valve housing 110 is screwed onto the valve stem 102 at second portion 122 of the valve stem 102 where internal threads of the valve housing 110 meet external threads of the valve stem 102 at mated threads 114. Third and fourth portions 121, 123 of the valve stem 102 include smooth external surfaces 124, 125, respectively. The fourth portion 123 is primarily for sealing against the valve housing 110 and the third portion 121 is primarily to provide clearance for the valve housing 110 to be screwed on to and off of the valve stem 102. The mated threads 114 hold the valve housing 110 in place on the valve stem 102, while a pair of O-rings 116, 118 housed within corresponding internal recesses 126, 128, respectively, of the valve housing 110 press against the smooth external surfaces 124, 125 of the valve stem 102, respectively, thereby sealing the valve housing 110 to the valve stem 102. Mounting the O-rings to the valve housing 110 rather than the poppet stem 130, as in some of the prior art, provides an easier and more reliable sealing interface. While two O-rings 116, 118 are illustrated and described above and used for redundancy to seal the valve housing 110 to the valve stem 102, greater or fewer O-rings or other sealing structures (e.g., x-rings) may be used to seal the valve housing 110 to the valve stem 102.

A poppet stem 130 extends from the valve stem 102, through a center of the valve housing 110, and protrudes out of a stem tip 132. The poppet stem 130 is axially aligned with the valve stem 102 and the valve housing 110. In the depicted closed orientation of the tubeless tire inflation valve 100, the poppet stem 130 circumferentially seats and seals against the valve housing 110. Specifically, the poppet stem 130 includes a circumferential seat 138 that seats against an internal circumferential seal (e.g., another O-ring 134 within a corresponding internal recess 136) within the valve housing 110. The O-ring 134 presses radially inward and axially against the smooth surface of the circumferential seat 138 on the poppet stem 130 to form the seal.

In other implementations, the valve housing 110 includes a circumferential seat that seats against an external circumferential seal (e.g., an O-ring within a corresponding internal recess) within the poppet stem 130. The O-ring presses outward against the smooth surface of the circumferential seat on the valve housing 110 to form the seal. As with the O-rings 116, 118 discussed above, the internal circumferential seal may include greater or fewer O-rings or other sealing structures (e.g., x-rings) to seal the poppet stem 130 against the valve housing 110.

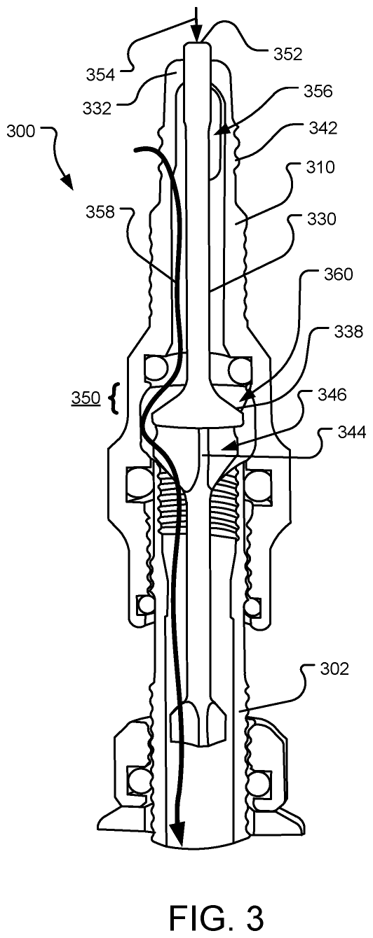

The poppet stem 130 may further include a centering feature 140 located at an end of the poppet stem 130 residing within the valve stem 102. The centering feature 140 aids the poppet stem 130 in staying axially aligned with the valve stem 102 and the valve housing 110, even as it is actuated between the depicted closed orientation and an open orientation (not shown, see e.g., FIG. 3). The centering feature 140 further allows air flow to pass by it in and out of the valve stem 102. The poppet stem 130 may further include tip threads 142 to accept corresponding internal threads for a dust cap or an inflator fitting.

The poppet stem 130 includes mechanical valve stem seats (e.g., mechanical seat 144) and poppet stem recesses (e.g., stem recess 146) arranged circumferentially around the poppet stem 130 below the internal circumferential seal. The mechanical valve stem seats are tapered stanchions that seat to the tip of the valve stem 102 in the depicted closed and secured orientation, as well as an open orientation (see e.g., tubeless tire inflation valve 300 of FIG. 3). The poppet stem recesses permit air flow around the mechanical valve stem seats and through the poppet stem 130 even when the mechanical valve stem seats are seated to the tip of the valve stem 102. As such, the combination allows for a mechanical seat to the valve stem 102, but airflow nonetheless, unless the internal circumferential seal at the circumferential seat 138 is made.

In the depicted closed and secured orientation, the valve housing 110 is screwed onto the valve stem 102 until the poppet stem 130 is compressed and secured between the valve stem 102 and the valve housing 110. Specifically, the valve stem seats press against the open end of the valve stem 102, while the poppet stem recesses permit air flow through the valve stem 102, even when the poppet stem 130 is mechanically seated to the valve stem 102. The internal circumferential seal provides downward pressure on the poppet stem 130 and against the valve stem 102. In the closed and secured orientation, no air can pass the internal circumferential seal and the poppet stem 130 is incapable of being actuated to an open orientation.

By making the valve housing 110 user adjustable with reference to the valve stem 102, the tubeless tire inflation valve 100 can not only be moved between secured and unsecured positions by the user, the tubeless tire inflation valve 100 can also be disassembled by the user by fully unscrewing the valve housing 110 from the valve stem 102. As the poppet stem 130 is kept in place between the valve stem 102 and the valve housing 110 by those structures, the poppet stem 130 can be readily removed once the valve housing 110 is removed from the valve stem 102. The disassembly is tool-less and permits the user to clean coagulated sealant from internal parts and passages of the tubeless tire inflation valve 100, as well as replace the valve housing 110 and/or the poppet stem 130, if desired. Further, the general placement of the valve housing 110 over the exposed end of the valve stem 102 and the circumferential seat 138 at the end of the valve stem 102 allows the tubeless tire inflation valve 100 to be easily disassembled without accessing the interior of the valve stem 102.

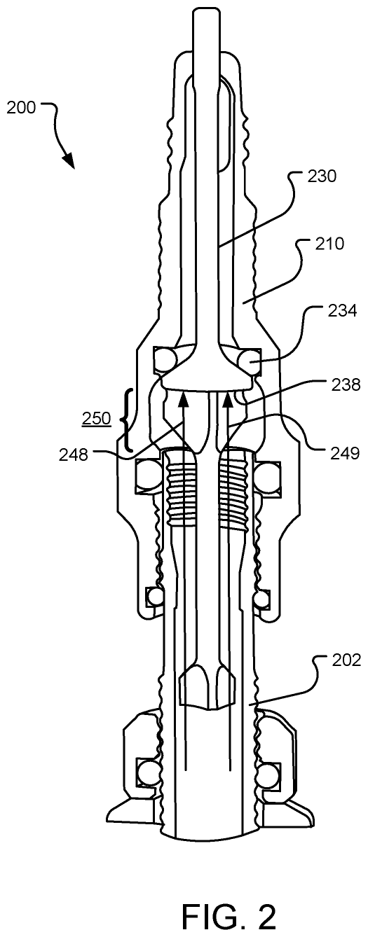

FIG. 2 illustrates a sectional view of an example tubeless tire inflation valve 200 in a closed and unsecured orientation. In the closed and unsecured orientation, valve housing 210 is partially screwed onto the valve stem 202 such poppet stem 230 is movable between the valve stem 202 and the valve housing 210.

To move the tubeless tire inflation valve 200 from a closed and secured orientation (see e.g., FIG. 1) to the depicted closed and unsecured orientation, a user rotates the valve housing 210 with reference to the valve stem 202 in a counterclockwise direction so that the valve housing 210 partially unscrews from the valve stem 202. This moves an open end of the valve stem 202 away from an internal circumferential seal formed by an O-ring 234 pressing against a smooth surface of circumferential seat 238 on the poppet stem 230. This opens an actuation gap 250 that permits the poppet stem 230 to be moved between the depicted closed orientation and an open orientation, as illustrated by FIG. 3 (discussed below).

As the valve stem 202 protrudes from a wheel (not shown, see e.g., wheel 104 of FIG. 1) onto which a pneumatic tire (not shown) is mounted, internal pressure from the tire presses the poppet stem 230 upwards against the valve housing 210, as illustrated by arrows 248, 249. This maintains the internal circumferential seal is any pressure is present in the tire. In other implementations, an internal spring (not shown) may be included to seat the poppet stem 230 to the valve housing 210 in the absence of tire pressure or to supplement the tire pressure.

FIG. 3 illustrates a sectional view of an example tubeless tire inflation valve 300 in an open orientation. In the open orientation, poppet stem 330 mechanically seats against valve stem 302 and is open to fluid flow through the valve stem 302 and valve housing 310 and around the poppet stem 330. To move the tubeless tire inflation valve 300 from a closed and unsecured orientation (see e.g., FIG. 2) to the depicted open orientation, a downward force is applied to the poppet stem 330 to unseat the poppet stem 330 from the valve housing 310 at circumferential seat 338. The downward force further seats the poppet stem 330 against the valve stem 302 in the open orientation.

The poppet stem 330 includes mechanical valve stem seats (e.g., mechanical seat 344) and poppet stem recesses (e.g., stem recess 346). In the open orientation, the mechanical valve stem seats rest against a circumferential tip of the valve stem 302 to prevent the poppet stem 330 from being pressed through the valve stem 302 and the fluid is permitted to flow through the poppet stem recesses around the poppet stem 330. The poppet stem recesses are placed between the mechanical seats circumferentially around the poppet stem 330. An actuation gap 350 permits the poppet stem 330 to be moved between the depicted open orientation and a closed orientation, as illustrated by FIG. 2 (discussed above).

As the valve stem 302 protrudes from a wheel (not shown, see e.g., wheel 104 of FIG. 1) onto which a pneumatic tire (not shown) is mounted, internal pressure from the tire presses the poppet stem 330 upwards against the valve housing 310 if any pressure is present in the tire to create a normally closed orientation for the tubeless tire inflation valve 300. In other implementations, an internal spring (not shown) may be included to seat the poppet stem 330 to the valve housing 310 in the absence of tire pressure or to supplement the tire pressure.

Downward force is applied to the poppet stem 330 to overcome the normally closed orientation for the tubeless tire inflation valve 300. The downward force may be a mechanical force, illustrated by arrow 354, applied to poppet tip 352 that overcomes the resisting force applied by internal pressure from the tire, if present, to move and hold the tubeless tire inflation valve 300 in the open orientation. The downward force may further be a pressure differential between the internal pressure from the tire and fluid pressure applied at fluid apertures (e.g., fluid aperture 356) at an end of the valve housing 310, wherein the fluid pressure applied to the valve housing 310 exceeds that of the tire. In some implementations, the downward force is a combination of the mechanical force illustrated by arrow 354, and the fluid pressure applied to the valve housing 310, particularly when the fluid pressure applied to the valve housing 310 does not exceeds that of the tire.

To inflate the tire, an inflator (e.g., an air compressor, pump, or other source of compressed air, not shown) is attached to the stem tip 332 (e.g., using tip threads 342 to accept corresponding internal threads for an inflator fitting). The inflator applies fluid pressure that exceeds that of the tire, thereby causing fluid flow from the inflator, through fluid apertures (e.g., fluid aperture 356) arranged around a periphery of the stem tip 332 into the valve housing 310 and through the valve housing 310 and around the poppet stem 330, into and through the valve stem 302, and ultimately into the tire to inflate it, as illustrated by arrow 358. Deflation of the tire takes a similar path in reverse if the fluid pressure applied to stem tip 332 does not exceed that of the tire, and the tubeless tire inflation valve 300 is held in the open orientation by mechanical force applied to poppet tip 352, for example.

In various implementations, the poppet stem 330 is greater than 4 mm at its widest point to prevent it from passing entirely through the valve stem 302 and potentially into the tire. The valve housing 310 is even larger in diameter to accommodate the poppet stem 330 within. An annular orifice 360 is created between the mechanical seat 344 of the poppet stem 330 and the valve housing 310. The annular orifice 360 is sized to minimize clogging caused by coagulated sealant passing through the tubeless tire inflation valve 300.

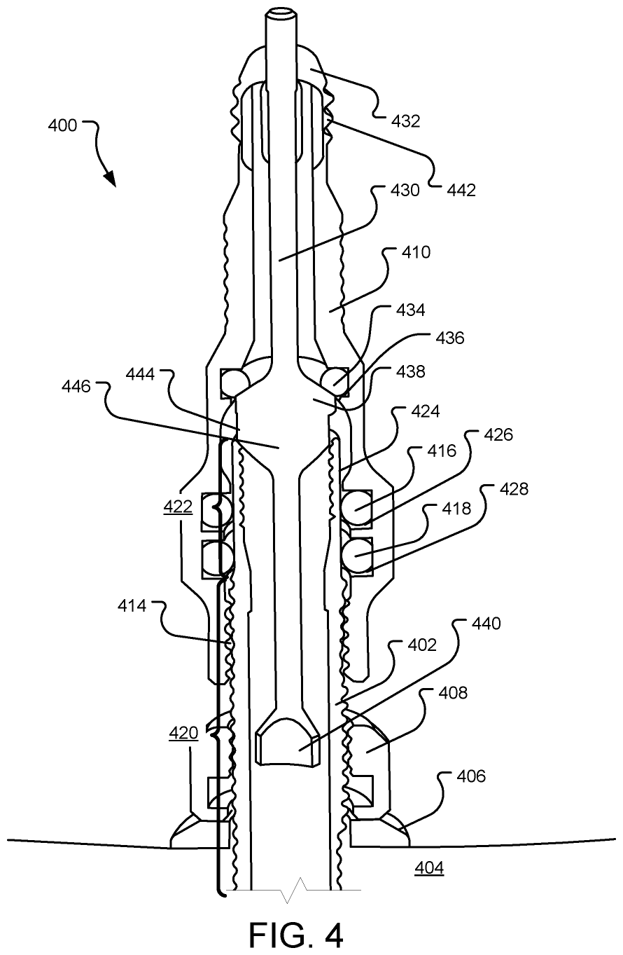

FIG. 4 illustrates a sectional view of another example tubeless tire inflation valve 400 in a closed and secured orientation. The tubeless tire inflation valve 400 includes a valve stem 402 that protrudes from a wheel (or rim) 404 onto which a pneumatic tire (not shown) is mounted. The valve stem 402 is sealed against the wheel 404 so that pressurized air is not permitted to escape from the wheel 404 at the interface of the wheel 404 with the valve stem 402. An optional reinforcing grommet 406 improves security of nut 408 compressed against the wheel 404 profile. A pneumatic seal occurs on an unshown end of the valve stem 402 via a tapered grommet that is pressed into the rim hole via force applied to the valve stem 402 via the nut 408. The valve stem 402 is customized for the presently disclosed technology (see e.g., smooth external surface 424 of top portion 422, discussed below), though common valve stem styles (e.g., Presta, Schrader, or Dunlop) could be used similarly.

A valve housing 410 is screwed onto and sealed against the valve stem 402. A base portion 420 of the valve stem 402 includes external threads for accepting corresponding internal threads of the nut 408, as discussed above, and corresponding internal threads of the valve housing 410 at mated threads 414. The top portion 422 of the valve stem 402 includes a smooth external surface 424 for sealing against the valve housing 410. The mated threads 414 hold the valve housing 410 in place on the valve stem 402, while a pair of O-rings 416, 418 housed within corresponding internal recesses 426, 428, respectively, of the valve housing 410 press against the smooth external surface 424 of the valve stem 402, thereby sealing the valve housing 410 to the valve stem 402. Mounting the O-rings to the valve housing 410 rather than the poppet stem 430, as in some of the prior art, provides an easier and more reliable sealing interface. While two O-rings 416, 418 are illustrated and described above and used for redundancy to seal the valve housing 410 to the valve stem 402, greater or fewer O-rings or other sealing structures (e.g., x-rings) may be used to seal the valve housing 410 to the valve stem 402.

A poppet stem 430 extends from the valve stem 402, through a center of the valve housing 410, and protrudes out of a stem tip 432. The poppet stem 430 is axially aligned with the valve stem 402 and the valve housing 410. In the depicted closed orientation of the tubeless tire inflation valve 400, the poppet stem 430 circumferentially seats and seals against the valve housing 410. Specifically, the poppet stem 430 includes a circumferential seat 438 that seats against an internal circumferential seal (e.g., another O-ring 434 within a corresponding internal recess 436) within the valve housing 410. The O-ring 434 presses radially inward and axially against the smooth surface of the circumferential seat 438 on the poppet stem 430 to form the seal.

In other implementations, the valve housing 410 includes a circumferential seat that seats against an external circumferential seal (e.g., an O-ring within a corresponding internal recess) within the poppet stem 430. The O-ring presses outward against the smooth surface of the circumferential seat on the valve housing 410 to form the seal. As with the O-rings 416, 418 discussed above, the internal circumferential seal may include greater or fewer O-rings or other sealing structures (e.g., x-rings) to seal the poppet stem 430 against the valve housing 410.

The poppet stem 430 may further include a centering feature 440 located at an end of the poppet stem 430 residing within the valve stem 402. The centering feature 440 aids the poppet stem 430 in staying axially aligned with the valve stem 402 and the valve housing 410, even as it is actuated between the depicted closed orientation and an open orientation (not shown, see e.g., FIG. 3). The centering feature 440 further allows air flow to pass by it in and out of the valve stem 402. The poppet stem 430 may further include tip threads 442 to accept corresponding internal threads for a dust cap or an inflator fitting.

The poppet stem 430 includes mechanical valve stem seats (e.g., mechanical seat 444) and poppet stem recesses (e.g., stem recess 446) arranged circumferentially around the poppet stem 430 below the internal circumferential seal. The mechanical valve stem seats are tapered stanchions that seat to the tip of the valve stem 402 in the depicted closed and secured orientation, as well as an open orientation (see e.g., tubeless tire inflation valve 300 of FIG. 3). The poppet stem recesses permit air flow around the mechanical valve stem seats and through the poppet stem 430 even when the mechanical valve stem seats are seated to the tip of the valve stem 402. As such, the combination allows for a mechanical seat to the valve stem 402, but airflow nonetheless, unless the internal circumferential seal at the circumferential seat 438 is made.

In the depicted closed and secured orientation, the valve housing 410 is screwed onto the valve stem 402 until the poppet stem 430 is compressed and secured between the valve stem 402 and the valve housing 410. Specifically, the valve stem seats press against the open end of the valve stem 402, while the poppet stem recesses permit air flow through the valve stem 402, even when the poppet stem 430 is mechanically seated to the valve stem 402. The internal circumferential seal provides downward pressure on the poppet stem 430 and against the valve stem 402. In the closed and secured orientation, no air can pass the internal circumferential seal and the poppet stem 430 is incapable for being actuated to an open orientation.

By making the valve housing 410 user adjustable with reference to the valve stem 402, the tubeless tire inflation valve 400 can not only be moved between secured and unsecured positions by the user, the tubeless tire inflation valve 400 can also be disassembled by the user by fully unscrewing the valve housing 410 from the valve stem 402. As the poppet stem 430 is kept in place between the valve stem 402 and the valve housing 410 by those structures, the poppet stem 430 can be readily removed once the valve housing 410 is removed from the valve stem 402. The disassembly is tool-less and permits the user to clean coagulated sealant from internal parts and passages of the tubeless tire inflation valve 400, as well as replace the valve housing 410 and/or the poppet stem 430, if desired. Further, the general placement of the valve housing 410 over the exposed end of the valve stem 402 and the circumferential seat 438 at the end of the valve stem 402 allows the tubeless tire inflation valve 400 to be easily disassembled without accessing the interior of the valve stem 402.

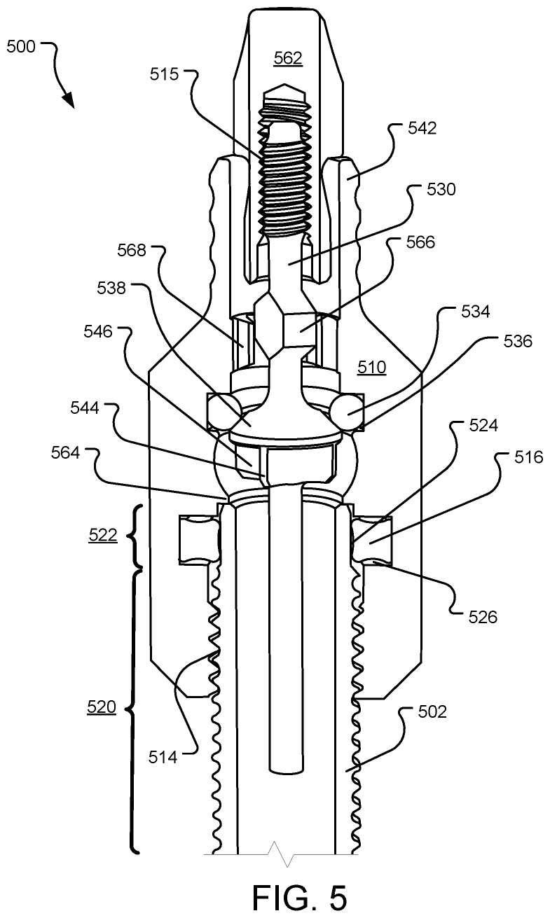

FIG. 5 illustrates a sectional view of another example tubeless tire inflation valve 500 in a closed and secured orientation. The tubeless tire inflation valve 500 includes a valve stem 502 that protrudes from a wheel (not shown, see e.g., wheel 104 of FIG. 1) onto which a pneumatic tire (not shown) is mounted. The valve stem 502 is sealed against the wheel so that pressurized air is not permitted to escape from the wheel at the interface of the wheel with the valve stem 502. The valve stem 502 is customized for the presently disclosed technology (see e.g., smooth external surface 524 of top portion 522, discussed below), though common valve stem styles (e.g., Presta, Schrader, or Dunlop) could be used similarly.

A valve housing 510 is screwed onto and sealed against the valve stem 502. A base portion 520 of the valve stem 502 includes external threads for accepting corresponding internal threads of the valve housing 510 at mated threads 514. The smooth external surface 524 of the top portion 522 seals against the valve housing 510. The mated threads 514 hold the valve housing 510 in place on the valve stem 502, while an X-ring 516 housed within an internal recess 526 of the valve housing 510 presses against the smooth external surface 524 of the valve stem 502, thereby sealing the valve housing 510 to the valve stem 502. While one X-ring 516 is illustrated and described above to seal the valve housing 510 to the valve stem 502, multiple X-rings or other sealing structures (e.g., O-rings) may be used to seal the valve housing 510 to the valve stem 502.

A poppet stem 530 extends from the valve stem 502, through a center of the valve housing 510, and screws into a stem cap 562. The poppet stem 530 is axially aligned with the valve stem 502 and the valve housing 510. In the depicted closed orientation of the tubeless tire inflation valve 500, the poppet stem 530 circumferentially seats and seals against the valve housing 510. Specifically, the poppet stem 530 includes a circumferential seat 538 that seats against an internal circumferential seal (e.g., O-ring 534 within a corresponding internal recess 536) within the valve housing 510. The O-ring 534 presses inward against the smooth surface of the circumferential seat 538 on the poppet stem 530 to form the seal.

In other implementations, the valve housing 510 includes a circumferential seat that seats against an external circumferential seal (e.g., an O-ring within a corresponding internal recess) within the poppet stem 530. The O-ring presses outward against the smooth surface of the circumferential seat on the valve housing 510 to form the seal. As with the X-ring 516 discussed above, the internal circumferential seal may include multiple X-rings or other sealing structures (e.g., O-rings) to seal the poppet stem 530 against the valve housing 510. The valve housing 510 may further include tip threads 542 to accept corresponding internal threads for a dust cap or an inflator fitting. The poppet stem 530 may further include an anti-rotation feature 566 located at an end of the poppet stem 530 residing within the valve housing 510 that engages with a corresponding anti-rotation feature 568 that is a part of the valve housing 510. The pairing of anti-rotation features 566, 568 prevents the poppet stem 530 from partially or fully rotating when the stem cap 562 is rotated. This permits the stem cap 562 to be readily screwed onto or unscrewed from the poppet stem 530, as desired by a user to close and secure the tubeless tire inflation valve 500 or un-secure and open the tubeless tire inflation valve 500.

The valve housing 510 is fully screwed onto the valve stem 502 until the valve stem 502 rests against circumferential stop 564. In the depicted closed and secured orientation, the stem cap 562 is screwed onto the threaded end of the poppet stem 530 at mated threads 515. This pulls the poppet stem 530 upward to create the internal circumferential seal between the valve housing 510 and the poppet stem 530. In the closed and secured orientation, no air can pass the internal circumferential seal and the poppet stem 530 is incapable for being actuated to an open orientation.

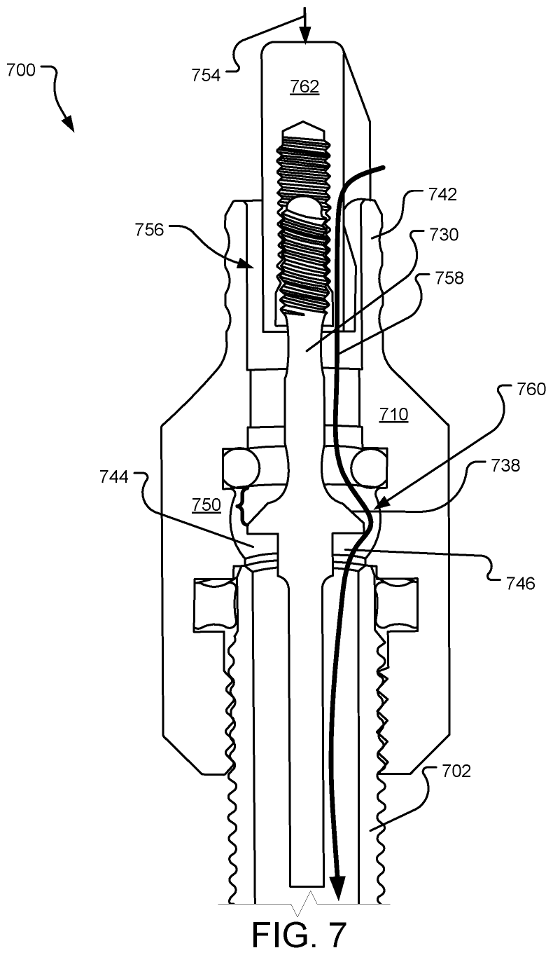

In an unsecured orientation, the stem cap 562 is partially unscrewed onto the threaded end of the poppet stem 530 at mated threads 515, thereby permitting the poppet stem 530 to move within the valve housing 510. The poppet stem 530 includes mechanical valve stem seats (e.g., mechanical seat 544 and poppet stem recesses (e.g., stem recess 546) arranged circumferentially around the poppet stem 530 below the internal circumferential seal. The mechanical valve stem seats are tapered stanchions that seat to the tip of the valve stem 502 in an open orientation (see e.g., tubeless tire inflation valve 700 of FIG. 7), permitted by unscrewing the stem cap 562 from the poppet stem 530. The poppet stem recesses permit air flow around the mechanical valve stem seats and through the poppet stem 530 even when the mechanical valve stem seats are seated to the tip of the valve stem 502. As such, the combination allows for a mechanical seat to the valve stem 502, but airflow around the mechanical seat, nonetheless.

By making the valve housing 510 user adjustable with reference to the valve stem 502, the tubeless tire inflation valve 500 can not only be moved between secured and unsecured positions by the user, the tubeless tire inflation valve 500 can also be disassembled by the user by fully unscrewing the valve housing 510 from the valve stem 502 and fully unscrewing the stem cap 562 from the poppet stem 530. The poppet stem 530 can then be readily removed once the valve housing 510. The disassembly is tool-less and permits the user to clean coagulated sealant from internal parts and passages of the tubeless tire inflation valve 500, as well as replace the valve housing 510, stem cap 562, and/or the poppet stem 530, if desired. Further, the general placement of the valve housing 510 over the exposed end of the valve stem 502 and the circumferential seat 538 at the end of the valve stem 502 allows the tubeless tire inflation valve 500 to be easily disassembled without accessing the interior of the valve stem 502.

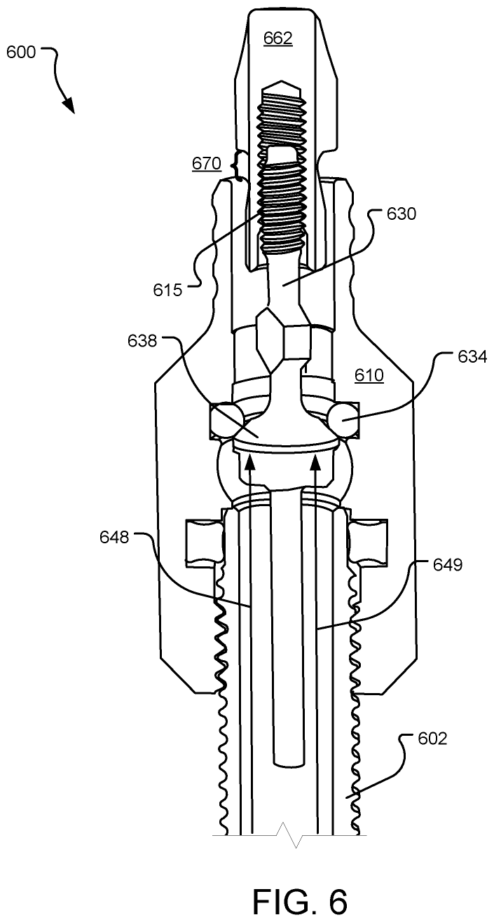

FIG. 6 illustrates a sectional view of an example tubeless tire inflation valve 600 in a closed and unsecured orientation. In the closed and unsecured orientation, stem cap 662 is partially (or fully) unscrewed from a threaded end of poppet stem 630 at mated threads 615, as compared to tubeless tire inflation valve 500 of FIG. 5, which is depicted in a closed and secured orientation. This position of the stem cap with reference to the poppet stem 630 renders the poppet stem 630 is movable between valve stem 602 and valve housing 610.

To move the tubeless tire inflation valve 600 from a closed and secured orientation (see e.g., FIG. 5) to the depicted closed and unsecured orientation, a user rotates the stem cap 662 with reference to the poppet stem 630 in a counterclockwise direction so that the stem cap 662 partially unscrews from the poppet stem 630. This moves the stem cap 662 upward with reference to the valve housing 610, opening end gap 670. The end gap 670 permits the poppet stem 630 to move within an actuation gap (not shown, see e.g., actuation gap 750 of FIG. 7) that permits the poppet stem 630 to be moved between the depicted closed orientation and an open orientation, as illustrated by FIG. 7 (discussed below).

As the valve stem 602 protrudes from a wheel (not shown, see e.g., wheel 104 of FIG. 1) onto which a pneumatic tire (not shown) is mounted, internal pressure from the tire presses the poppet stem 630 upwards against the valve housing 610, as illustrated by arrows 648, 649. This maintains an internal circumferential seal between circumferential seat 638 and O-ring 634 if any pressure is present in the tire. In other implementations, an internal spring (not shown) may be included to seat the poppet stem 630 to the valve housing 610 in the absence of tire pressure or to supplement the tire pressure.

FIG. 7 illustrates a sectional view of another example tubeless tire inflation valve 700 in an open orientation. In the open orientation, poppet stem 730 mechanically seats against valve stem 702 and is open to fluid flow through the valve stem 702 and valve housing 710 and around the poppet stem 730. To move the tubeless tire inflation valve 700 from a closed and unsecured orientation (see e.g., FIG. 5) to the depicted open orientation, a downward force is applied to the poppet stem 730 to unseat the poppet stem 730 from the valve housing 710 at circumferential seat 738. The downward force further seats the poppet stem 730 against the valve stem 702 in the open orientation.

The poppet stem 730 includes mechanical valve stem seats (e.g., mechanical seat 744) and poppet stem recesses (e.g., stem recess 746). In the open orientation, the mechanical valve stem seats rest against a circumferential tip of the valve stem 702 to prevent the poppet stem 730 from being pressed through the valve stem 702 and the fluid is permitted to flow through the poppet stem recesses around the poppet stem 730. The poppet stem recesses are placed between the mechanical seats circumferentially around the poppet stem 730. An actuation gap 750 permits the poppet stem 730 to be moved between the depicted open orientation and a closed orientation, as illustrated by FIG. 5 (discussed above). In some implementations, an end gap (e.g., end gap 570 of FIG. 5) is further completely closed in the depicted open orientation, and mechanical interference between stem cap 762 and an open end of the valve housing 710 limits the stroke of the poppet stem 730 within the valve housing 710.

As the valve stem 702 protrudes from a wheel (not shown, see e.g., wheel 104 of FIG. 1) onto which a pneumatic tire (not shown) is mounted, internal pressure from the tire presses the poppet stem 730 upwards against the valve housing 710 if any pressure is present in the tire to create a normally closed orientation for the tubeless tire inflation valve 700. In other implementations, an internal spring (not shown) may be included to seat the poppet stem 730 to the valve housing 710 in the absence of tire pressure or to supplement the tire pressure.

Downward force is applied to the poppet stem 730 to overcome the normally closed orientation for the tubeless tire inflation valve 700. The downward force may be a mechanical force, illustrated by arrow 754, applied to the stem cap 762 that overcomes the resisting force applied by internal pressure from the tire, if present, to move and hold the tubeless tire inflation valve 700 in the open orientation. The downward force may further be a pressure differential between the internal pressure from the tire and fluid pressure applied at fluid apertures (e.g., fluid aperture 756) at an end of the valve housing 710, wherein the fluid pressure applied to the valve housing 710 exceeds that of the tire. In some implementations, the downward force is a combination of the mechanical force illustrated by arrow 754, and the fluid pressure applied to the valve housing 710, particularly when the fluid pressure applied to the valve housing 710 does not exceeds that of the tire.

To inflate the tire, an inflator (e.g., an air compressor, pump, or other source of compressed air, not shown) is attached to the valve housing 710 (e.g., using tip threads 742 to accept corresponding internal threads for an inflator fitting). The inflator applies fluid pressure that exceeds that of the tire, thereby causing fluid flow from the inflator, through fluid apertures (e.g., fluid aperture 756) arranged around a periphery of the valve housing 710 into the valve housing 710 and through the valve housing 710 and around the poppet stem 730, into and through the valve stem 702, and ultimately into the tire to inflate it, as illustrated by arrow 758. Deflation of the tire takes a similar path in reverse if the fluid pressure applied to the valve housing 710 does not exceed that of the tire, and the tubeless tire inflation valve 700 is held in the open orientation by mechanical force applied to the stem cap 762, for example.

In various implementations, the poppet stem 730 is greater than 4 mm at its widest point to prevent it from passing entirely through the valve stem 702 and potentially into the tire. The valve housing 710 is even larger in diameter to accommodate the poppet stem 730 within. An annular orifice 760 is created between the mechanical seat 744 of the poppet stem 730 and the valve housing 710. The annular orifice 760 is sized to minimize clogging caused by coagulated sealant passing through the tubeless tire inflation valve 700.

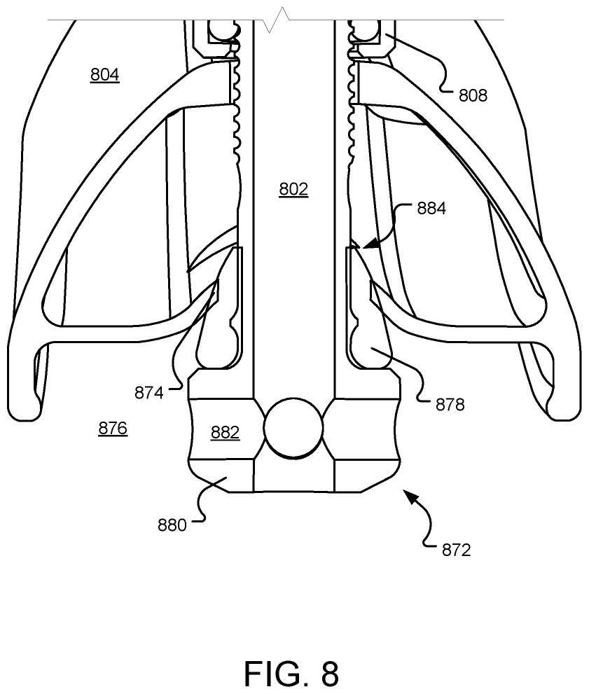

FIG. 8 illustrates a radial sectional view of a bicycle wheel 804 and a valve stem 802 with an asymmetric stopper 872 protruding therefrom. A tubeless tire inflation valve (not shown, see e.g., tubeless tire inflation valve 100 of FIG. 1) includes the valve stem 802 that protrudes from the bicycle wheel or rim 804 onto which a pneumatic tire (not shown) is mounted. The valve stem 802 is sealed against an exterior-facing (or tire-facing) surface of the wheel 804 so that pressurized air 876 within the pneumatic tire is not permitted to escape from the wheel 804 at an interface 874 of the wheel 804 with the valve stem 802. The valve stem 802 may be customized for the presently disclosed technology, though common valve stem styles (e.g., Presta, Schrader, or Dunlop) may also be used.

While a variety of sealed interfaces are contemplated herein, the depicted asymmetric stopper 872 utilizes an asymmetric profile that may match a corresponding asymmetric profile of the exterior-facing surface of the wheel 804 where the valve stem 802 protrudes through a valve hole 884 in the bicycle wheel 804. The asymmetric stopper 872 is pulled radially inward against the valve hole 884 via inward force applied to the valve stem 802 via the nut 808 by screwing the nut 808 onto the valve stem 802. A tapered grommet 878 that forms part of the asymmetric stopper 872 is pressed into the valve hole 884 by the inward force, thereby creating a pneumatic seal at the interface 874 near the end of the valve stem 802 that protrudes within the pneumatic tire.

The asymmetric stopper 872 forms a distal end of the valve stem 802 that resides radially outside of the wheel 804 and within the pneumatic tire. The asymmetric stopper 872 includes a rigid body 880 that defines air passages (e.g., air passage 882) that permit air to flow through the valve stem 802 from the pneumatic tire, when the tubeless tire inflation valve is open. The rigid body 880 further holds the tapered grommet 878 in place on the asymmetric stopper 872. The tapered grommet 878 has an asymmetric profile that may match a corresponding asymmetric profile of the exterior-facing surface of the wheel 804 around the valve hole 884.

The asymmetric profile of the wheel 804 is a result of a complex three-dimensional curvature of the radially outward-facing surface (or tire-facing surface) of the wheel 804. A symmetric grommet as provided in the prior art creates pressure points when used in conjunction with valve holes in wheels with such a complex curvature, where the grommet is substantially more compressed in some areas than in other areas, thereby reducing the effectiveness of the pneumatic seal. The presently disclosed asymmetric stopper 872 addresses this issue and more evenly distributes pressure between the asymmetric stopper 872 and the wheel 804 under compression than the prior art. In various implementations, the asymmetric profile of the wheel 804 may be curved on two perpendicular axes and the asymmetric stopper 872 is similarly curved to achieve a profile that may match the asymmetric profile of the wheel 804 and other similarly curved wheels. The tapered grommet 878 is made of a material that deflects under compression to create the pneumatic seal at the interface 874. In various implementations, the tapered grommet 878 is resiliently deflectable (e.g., made of a soft material, such as various elastomers) or permanently deflectable (e.g., made of a semi-metallic or metallic material).

The asymmetric stopper 872 is tapered and has a profile with conical and elliptical characteristics that may or may not match a similar asymmetric profile around the valve hole 884 of the wheel 804. For example, a section cut of the asymmetric stopper 872 would show that the outer circumference at a section plane near the end of the asymmetric stopper 872 is largely circular, whereas a section plane cut near the wider region of the asymmetric stopper 872 would show that it is substantially elliptical. The resulting shape is an elliptical cone that allows the asymmetric stopper 872 to interface more effectively with a wider range of rim profiles and a wider range of hole diameters in those profiles, and not necessarily a singular corresponding profile of the wheel 804.

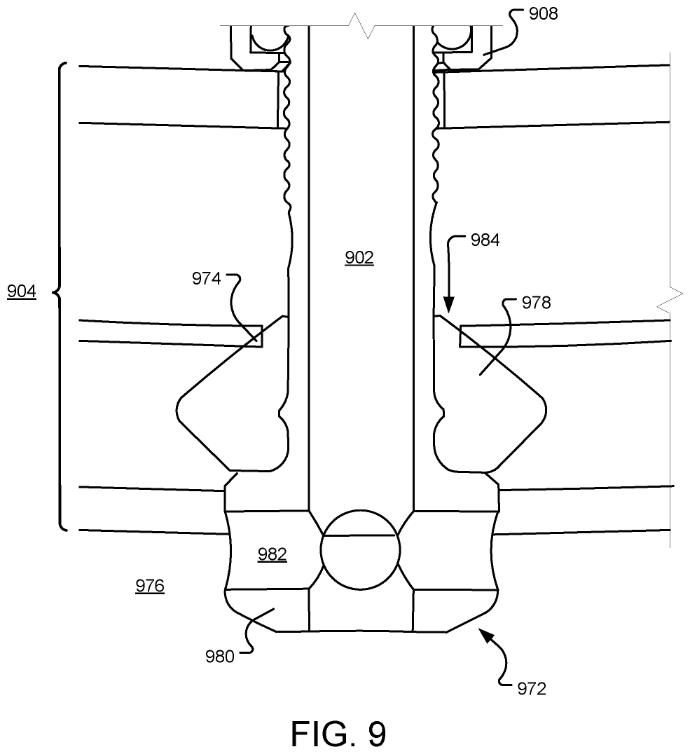

FIG. 9 illustrates a transverse sectional view of a bicycle wheel 904 and a valve stem 902 with an asymmetric stopper protruding therefrom 972. A tubeless tire inflation valve (not shown, see e.g., tubeless tire inflation valve 100 of FIG. 1) includes the valve stem 902 that protrudes from the bicycle wheel or rim 904 onto which a pneumatic tire (not shown) is mounted. The valve stem 902 is sealed against an exterior-facing (or tire-facing) surface of the wheel 904 so that pressurized air 976 within the pneumatic tire is not permitted to escape from the wheel 904 at an interface 974 of the wheel 904 with the valve stem 902. The valve stem 902 may be customized for the presently disclosed technology, though common valve stem styles (e.g., Presta, Schrader, or Dunlop) may also be used.

While a variety of sealed interfaces are contemplated herein, the depicted asymmetric stopper 972 utilizes an asymmetric profile that may match a corresponding asymmetric profile of the exterior-facing surface of the wheel 904 where the valve stem 902 protrudes through a valve hole 984 in the bicycle wheel 904. The asymmetric stopper 972 is pulled radially inward against the valve hole 984 via inward force applied to the valve stem 902 via the nut 908 by screwing the nut 908 onto the valve stem 902. A tapered grommet 978 that forms part of the asymmetric stopper 972 is pressed into valve hole 984 by the inward force, thereby creating a pneumatic seal at the interface 974 near the end of the valve stem 902 that protrudes within the pneumatic tire.

The asymmetric stopper 972 forms a distal end of the valve stem 902 that resides radially outside of the wheel 904 and within the pneumatic tire. The asymmetric stopper 972 includes a rigid body 980 that defines air passages (e.g., air passage 982) that permit air to flow through the valve stem 902 from the pneumatic tire, when the tubeless tire inflation valve is open. The rigid body 980 further holds the tapered grommet 978 in place on the asymmetric stopper 972. The tapered grommet 978 has an asymmetric profile that may match a corresponding asymmetric profile of the exterior-facing surface of the wheel 904 at the valve hole 984. In various implementations, the asymmetric profile of the wheel 904 may be curved on two perpendicular axes and the asymmetric stopper 972 is similarly curved to achieve a profile that may match the asymmetric profile of the wheel 904 and other similarly curved wheels. The tapered grommet 978 is made of a material that deflects under compression to create the pneumatic seal at the interface 974.

The asymmetric stopper 972 is tapered and has a profile with conical and elliptical characteristics that may or may not match a similar asymmetric profile around the valve hole 984 of the wheel 904. For example, a section cut of the asymmetric stopper 972 would show that the outer circumference at a section plane near the end of the asymmetric stopper 972 is largely circular, whereas a section plane cut near the wider region of the asymmetric stopper 972 would show that it is substantially elliptical. The resulting shape is an elliptical cone that allows the asymmetric stopper 972 to interface more effectively with a wider range of rim profiles and a wider range of hole diameters in those profiles, and not necessarily a singular corresponding profile of the wheel 804

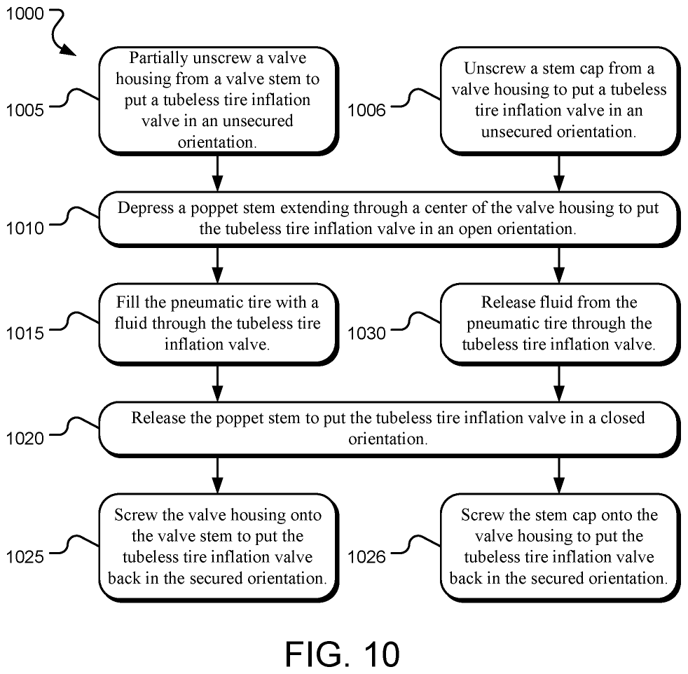

FIG. 10 illustrates example operations 1000 for using a tubeless tire inflation valve to fill or release fluid from a pneumatic tire. Operations 1005-1026 may be used to inflate or deflate the pneumatic tire using the tubeless tire inflation valve. A partially unscrewing operation 1005 partially unscrews a valve housing from a valve stem to put the tubeless tire inflation valve in an unsecured orientation. The valve stem protrudes from a wheel onto which the pneumatic tire is mounted. The unscrewing operation 1005 creates an actuation gap within the valve housing that permits the tubeless tire inflation valve to be moved between open and closed orientations while unsecured. In other implementations, a partially unscrewing operation 1006 partially unscrews a stem cap from a valve housing to put the tubeless tire inflation valve in an unsecured orientation.

A depressing operation 1010 depresses a poppet stem extending through a center of the valve housing to put the tubeless tire inflation valve in an open orientation. In the open orientation, the poppet stem mechanically seats against the valve stem and is open to fluid flow through the valve stem and the valve housing and around the poppet stem. The poppet stem may be depressed manually, either directly or via the stem cap. The poppet stem may also be depressed by a pressure differential between a fluid supply to the valve housing and fluid pressure within the pneumatic tire. Some implementations may use both mechanisms together to depress the poppet stem.

A filling operation 1015 fills the pneumatic tire with a fluid such as air through the tubeless tire inflation valve. An air fitting may be attached to the valve housing to supply compressed air through valve housing to fill the pneumatic tire. A releasing operation 1030 releases fluid from the pneumatic tire through the tubeless tire inflation valve. Either or both of the filling operation 1015 and the releasing operation 1030 may be performed responsive to the depressing operation 1010. Another releasing operation 1020 releases the poppet stem to put the tubeless tire inflation valve in a closed orientation. In the closed orientation, the poppet stem circumferentially seats and seals against the valve housing. Operations 1010, 1020 are generally achieved by a pressure differential between air within the pneumatic tire and any depressing force on the poppet stem (e.g., a mechanism force or air pressure applied to fill the pneumatic tire (e.g., at operation 1015).

A reattachment operation 1025 screws the valve housing onto the valve stem to put the tubeless tire inflation valve back in a secured orientation. The reattachment operation 1025 closes the actuation gap within the valve housing and locks the tubeless tire inflation valve in the closed orientation. In other implementations, a reattachment operation 1026 screws the stem cap onto the valve housing to put the tubeless tire inflation valve in the secured orientation.

For a filled pneumatic tire, operations 1005/1006, 1010 may be performed to place the tubeless tire inflation valve in an open and unsecured orientation to deflate the tubeless tire with releasing operation 1030 used to release air from the pneumatic tire through the tubeless tire inflation valve. Operations 1020, 1025/1026 may then be performed to place the tubeless tire inflation valve back in a closed and secured orientation.

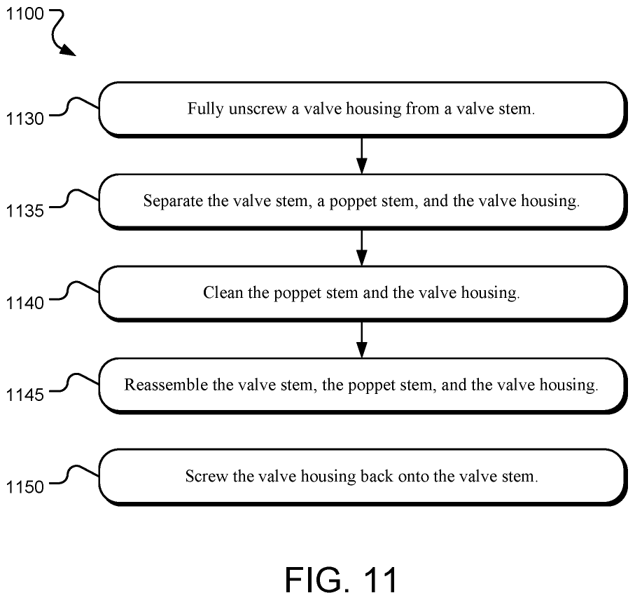

FIG. 11 illustrates example operations 1100 for removing a tubeless tire inflation valve from a valve stem for cleaning or replacement. Operations 1130-1150 may be used to disassemble, clean, and re-assemble the tubeless tire inflation valve. An unscrewing operation 1130 disconnects the valve housing from the valve stem. The unscrewing operation 1130 renders the valve stem, poppet stem, and valve housing readily separable. In other implementations, the unscrewing operation 1130 includes unscrewing a separate stem cap from the valve housing as well.

A separating operation 1135 separates the valve stem, poppet stem, and valve housing. A cleaning operation 1140 cleans the poppet stem and the valve housing, particularly internal fluid passages that may be partially or fully blocked by build-up of coagulated sealant that previously passed through the tubeless tire inflation valve. A re-assembling operation 1145 reassembles the valve stem, poppet stem, and valve housing. Reattachment operation 1150 is repeated to screw the valve housing back onto the valve stem. The reattachment operation 1150 may be performed partially to put the tubeless tire inflation valve back in an unsecured orientation. The reattachment operation 1150 may also be performed fully to put the tubeless tire inflation valve in a secured orientation, in some cases subsequent to putting the tubeless tire inflation valve back in the unsecured orientation. In other implementations, the reattachment operation 1150 is performed fully to reattach the tubeless tire inflation valve to the valve stem, and the separate stem cap is used to define the unsecured or secured orientation of the tubeless tire inflation valve.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A tubeless tire inflation valve comprising:
a valve housing to be screwed onto and sealed against a valve stem, the valve stem protruding from a wheel onto which a pneumatic tire is mounted; and
a poppet stem extending through a center of the valve housing, the poppet stem axially aligned with the valve stem and the valve housing, wherein:
in a closed orientation of the tubeless tire inflation valve, the poppet stem circumferentially seats and seals against the valve housing; and
in an open orientation of the tubeless tire inflation valve, the poppet stem mechanically seats against the valve stem and is open to fluid flow through the valve stem and the valve housing and around the poppet stem.

2. The tubeless tire inflation valve of claim 1, further comprising:
the valve stem protruding from the wheel, wherein the valve stem includes:
a base portion with external threads for accepting corresponding internal threads of the valve housing; and
a top portion with a smooth external surface for sealing against the valve housing.

3. The tubeless tire inflation valve of claim 1, further comprising:
the valve stem including an asymmetric stopper to seal the valve stem to an interior surface of the wheel.

4. The tubeless tire inflation valve of claim 3, wherein the asymmetric stopper includes a tapered grommet with an elliptical cone shape.

5. The tubeless tire inflation valve of claim 1, wherein in the closed orientation of the tubeless tire inflation valve, the poppet stem is to be circumferentially seated against an internal circumferential seal within the valve housing.

6. The tubeless tire inflation valve of claim 5, wherein the internal circumferential seal includes one or more O-rings or x-rings.

7. The tubeless tire inflation valve of claim 1, wherein the poppet stem includes mechanical valve stem seats and poppet stem recesses, and wherein in the open orientation of the tubeless tire inflation valve, the mechanical valve stem seats rest against a circumferential tip of the valve stem and fluid is to flow through the poppet stem recesses, the poppet stem recesses placed between the mechanical valve stem seats circumferentially around the poppet stem.

8. The tubeless tire inflation valve of claim 1, wherein:
in a closed orientation and unsecured orientation, the valve housing is partially screwed onto the valve stem such the poppet stem is movable between the valve stem and the valve housing; and
in a closed and secured orientation, the valve housing is further screwed onto the valve stem until the poppet stem is compressed and secured between the valve stem and the valve housing.

9. The tubeless tire inflation valve of claim 1, further comprising:
a stem cap to be screwed onto an end of the poppet stem residing within the valve housing, wherein:
in a closed and unsecured orientation, the stem cap is removed from or partially screwed onto the poppet stem such the poppet stem is movable between the valve stem and the valve housing and there is a gap between the stem cap and the valve housing; and
in a closed and secured orientation, the stem cap is further screwed onto the poppet stem until it seats against the valve housing and the poppet stem is pulled and secured against the valve housing.

10. The tubeless tire inflation valve of claim 1, wherein the poppet stem includes a centering feature located at an end of the poppet stem residing within the valve stem.

11. The tubeless tire inflation valve of claim 1, wherein the poppet stem includes an anti-rotation feature located at an end of the poppet stem residing within the valve housing.

12. The tubeless tire inflation valve of claim 1, wherein the valve housing includes tip threads to accept corresponding internal threads for a dust cap or an inflator fitting.

13. The tubeless tire inflation valve of claim 1, wherein the valve stem is that of one of a Presta valve, a Schrader valve, or a Dunlop valve.

14. The tubeless tire inflation valve of claim 1, wherein the valve stem fluidly connects to an interior of the pneumatic tire.

15. The tubeless tire inflation valve of claim 1, wherein the valve housing and the poppet stem are removable from the valve stem by unscrewing the valve housing from the valve stem and pulling the valve housing away from the valve stem.

16. A bicycle wheel for mounting a tubeless tire comprising:
a rim to be sealed to a tubeless tire;
a valve stem protruding from the bicycle wheel and sealed to the bicycle wheel, the valve stem fluidly connected to an interior of the tubeless tire;
a valve housing to be screwed onto and sealed against the valve stem; and
a poppet stem extending through a center of the valve housing, the poppet stem axially aligned with the valve stem and the valve housing, wherein:
in a closed orientation, the poppet stem circumferentially seats and seals against the valve housing; and
in an open orientation, the poppet stem mechanically seats against the valve stem and is open to fluid flow through the valve stem and the valve housing and around the poppet stem.

17. The bicycle wheel of claim 16, wherein the valve stem includes:
a base portion with external threads for accepting corresponding internal threads of the valve housing; and
a top portion with a smooth external surface for sealing against the valve housing.

18. The bicycle wheel of claim 16, wherein the valve stem includes an asymmetric stopper to seal the valve stem to an interior surface of the rim.

19. The bicycle wheel of claim 18, wherein the asymmetric stopper includes a tapered grommet with an elliptical cone shape.

20. The bicycle wheel of claim 16, wherein in the closed orientation, the poppet stem is to be circumferentially seated against an internal circumferential seal within the valve housing.

21. The bicycle wheel of claim 20, wherein the internal circumferential seal includes one or more O-rings or x-rings.

22. A method of inflating a pneumatic tire using a tubeless tire inflation valve comprising:
partially unscrewing a valve housing from a valve stem to put the tubeless tire inflation valve in a unsecured orientation, the valve stem protruding from a wheel onto which the pneumatic tire is mounted;
depressing a poppet stem extending through a center of the valve housing to put the tubeless tire inflation valve in an open orientation, the poppet stem axially aligned with the valve stem and the valve housing, wherein in the open orientation, the poppet stem mechanically seats against the valve stem and is open to fluid flow through the valve stem and the valve housing and around the poppet stem;
filling the pneumatic tire with a fluid through the tubeless tire inflation valve;
releasing the poppet stem to put the tubeless tire inflation valve in a closed orientation, wherein in the closed orientation, the poppet stem circumferentially seats and seals against the valve housing; and
screwing the valve housing onto the valve stem to put the tubeless tire inflation valve in a secured orientation.

23. The method of claim 22, further comprising:
partially unscrewing the valve housing from the valve stem to put the tubeless tire inflation valve back in the unsecured orientation;
depressing the poppet stem to put the tubeless tire inflation valve back in the open orientation; and
releasing fluid from the pneumatic tire through the tubeless tire inflation valve.

24. The method of claim 22, further comprising:
fully unscrewing the valve housing from the valve stem;
separating the valve stem, poppet stem, and valve housing;
cleaning the poppet stem and the valve housing;
re-assembling the valve stem, poppet stem, and valve housing; and
screwing the valve housing back onto the valve stem.
